(19) United States
(12) Patent Application Publication
(10) Pub. No.: US 2025/0370351 A1
(43) Pub. Date: Dec. 4, 2025

(54) SYSTEM HAVING A LITHOGRAPHY APPARATUS AND A NUMBER OF ELECTRONICS MODULES, AND METHOD FOR OPERATING A SYSTEM

(71) Applicant: Carl Zeiss SMT GmbH, Oberkochen (DE)

(72) Inventors: Stefan KRONE, Ellwangen (DE); Daniel Kai HOFFMANN, Oberkochen (DE); Christian KEMPTER, Wittislingen (DE); Markus HOLZ, Aalen (DE)

(21) Appl. No.: 19/296,296

(22) Filed: Aug. 11, 2025

Related U.S. Application Data
(63) Continuation of application No. PCT/EP2024/051842, filed on Jan. 26, 2024.

(30) Foreign Application Priority Data
Feb. 13, 2023 (DE) 10 2023 201 138.7

(51) Int. Cl. G03F 7/00; G06F 21/31

(52) U.S. Cl. CPC G03F 7/70525; G03F 7/70808; G03F 7/70975; G03F 7/70991; G06F 21/31

(57) ABSTRACT

A system includes a lithography apparatus with a number N of electronics modules for a number of actuator/sensor devices of the lithography apparatus, where N≥1. The electronics module comprises a software component with a plurality of software functionalities. The software component is operable in a plurality of different modes of operation, which comprise a default mode and a service mode. A first set of the software functionalities, which is formed as a subset, can be executed in the default mode. A second set of the software functionalities, which is larger than the first set, can be executed in the service mode.

### CROSS-REFERENCE TO RELATED APPLICATIONS

The present application is a continuation of, and claims benefit under 35 USC 120 to, international application No. PCT/EP2024/051842, filed Jan. 26, 2024, which claims benefit under 35 USC 119 of German Application No. 10 2023 201 138.7, filed Feb. 13, 2023. The entire disclosure of each of these applications is incorporated by reference herein.

### FIELD

The present disclosure relates to a system having a lithography apparatus and a number of electronics modules for a number of actuator/sensor devices of the lithography apparatus. Furthermore, the disclosure relates to a method for operating a system having a lithography apparatus and a number of electronics modules for a number of actuator/sensor devices of the lithography apparatus.

### BACKGROUND

Microlithography is used to produce microstructured component parts, for example integrated circuits. The microlithography process is performed using a lithography apparatus that comprises an illumination system and a projection system. The image of a mask (reticle) illuminated using the illumination system is projected by the projection system onto a substrate, for example a silicon wafer, which is coated with a light-sensitive layer (photoresist) and is arranged in the image plane of the projection system, in order to transfer the mask structure to the light-sensitive coating of the substrate.

Driven by a desire for ever smaller structures in the production of integrated circuits, EUV lithography apparatuses that use light at a wavelength in the range from 0.1 nm to 30 nm, for example 13.5 nm, are currently under development. Since most materials absorb light at this wavelength, such EUV lithography apparatuses typically use reflective optics units, i.e. mirrors, instead of refractive optics units, i.e. lens elements, as used previously.

A multiplicity of actuator/sensor devices, such as sensors and actuators, are often installed in an optical system of a lithography apparatus. In general, an actuator/sensor device is suitable for displacing an optical element, for example a mirror, assigned to the actuator/sensor device and/or for detecting a parameter of the assigned optical element, for instance a position of the assigned optical element or a temperature of the assigned optical element.

For control and evaluation purposes, the actuator/sensor devices of the optical system are connected to a controller that is arranged outside the vacuum housing of the optical system. For example, the external controller is arranged in a gray room or a clean room. For example, the external controller is configured to provide control signals for the actuator/sensor devices and evaluate data received from the actuator/sensor devices.

The electronics, also referred to as electronics modules or electronic units, for the actuator/sensor devices and also for other sensors of the lithography apparatus, such as temperature sensors, may be located outside the lithography apparatus or within the lithography apparatus.

Lithography apparatuses can be relatively complex and have a relatively high optical accuracy, which can involve a system-specific parameterization and calibration. Also due to the relatively high production costs of lithography apparatuses, it can be desirable for the lithography apparatuses to be functionally diagnosed, expanded and optimized during their period of operation without requiring the removal and/or replacement of main components of the lithography apparatus. For this reason, the majority of electronics modules in lithography apparatuses often also contain programmable software, also referred to as programmable software components, or software components for short, hereinafter. Using these software components, lithography apparatuses can be individually configured, operated and, in the event of a fault, also diagnosed specifically.

These software components can offer great flexibility for the optimal use and individual configuration of lithography apparatuses. However, the use of programmable software components may also harbor certain risks and issues outlined below. Incorrect system configurations and improper use of available software components may cause damage, including accidental damage, to components of the lithography apparatus. Moreover, unprotected access to system data using available software components may also lead to the inadvertent disclosure of technical know-how by the user, for example regarding the system design and system use.

### SUMMARY

The present disclosure seeks to provide improved operation of a lithography apparatus.

According to a first aspect, a system is proposed, having a lithography apparatus and a number N of electronics modules for a number of actuator/sensor devices of the lithography apparatus, where N≥1. The electronics module has a software component with a plurality of software functionalities. The software component is operable in a plurality of different modes of operation at least comprising a default mode and at least one service mode. A first set of software functionalities, which is formed as a subset, can be executed by the software component in the default mode. A second set of the software functionalities, which is larger than the first set, can be executed by the software component in the service mode.

The software component of the present electronics module may be operated selectively in a default mode or in a service mode. The first set of software functionalities, which can be executed in the default mode, can comprise software functionalities for operating the lithography apparatus. The second set of software functionalities, which can be executed in the service mode, can comprise the software functionalities of the first set and, additionally, software functionalities directed to diagnostics and/or software functionalities directed to reparameterizations of the lithography apparatus, for example of the at least one actuator/sensor device. Hence the default mode may have a limited range of functions, which is configured for normal system operation, especially for users without expert knowledge and without special authorization, such as for wafer exposure. By contrast, the service mode may have an extended range of functions in comparison, for example extended for diagnostics and reparameterizations. The reparameterizations for example also comprise the modification of the system configuration of the lithography apparatus.

By contrast, not all implemented software functionalities are available to the user in the default mode. For example, the software functionalities that can be used in the default mode are a proper subset of the implemented software functionalities of the software component. This subset (proper subset) of software functionalities cannot damage system components and make knowhow-sensitive system data available to the user on account of its limited system scope. This ensures that damage to system components and an unwanted disclosure of technical system properties and system uses are prevented in the default mode.

The default mode may also be referred to as normal mode or production mode. The service mode may also be referred to as diagnostic mode. The software functionalities may also be referred to as software functions. The respective software functionality may also be implemented as a software application or application.

The lithography apparatus or projection exposure apparatus may be an EUV lithography apparatus. EUV stands for “extreme ultraviolet” and denotes a wavelength of the operating light between 0.1 nm and 30 nm. The lithography apparatus may also be a DUV lithography apparatus. DUV stands for “deep ultraviolet” and denotes a wavelength of the operating light between 30 nm and 465 nm. For example, the N electronics modules are part of an optical system of the lithography apparatus. The optical system can be an illumination system of the lithography apparatus or projection exposure apparatus. However, the optical system may also be a projection optics unit.

For example, the respective actuator/sensor device is an actuator (or actuating element) for actuating an optical element, a sensor for sensing an optical element or surroundings within the optical system, or an actuator and sensor device for actuating and sensing within the optical system. For example, the sensor is a position sensor. The actuator can be an actuator using the electrostrictive effect or an actuator using the piezoelectric effect, for example a PMN actuator (PMN; lead magnesium niobate) or a PZT actuator (PZT; lead zirconate titanate). Further examples of actuators are based on Lorenz forces/magnetic fields, heating wires and infrared lamps. For example, the actuator is configured to actuate an optical element of the optical system. Examples of such an optical element include lens elements, mirrors and adaptive mirrors.

According to an embodiment, the system comprises an authentication unit assigned to the software component. The authentication unit is configured to enable the at least one service mode on the basis of a piece of entered authentication information.

By using the authentication information associated with the service mode, it is possible to allow access to the service mode only to those users who have available the authentication information associated with the service mode. This authentication information can be verified by the authentication unit prior to each change in mode of operation and/or every time the user logs onto the lithography apparatus.

The present authentication affords the lithography apparatus and/or its system data particular protection since the service mode involves authorization using the authentication information. For example, this authorization may be implemented by a password query. In this case, the authentication information is formed by an appropriate password. The software functionalities of the service mode are enabled for the user only once the user has transmitted the correct password and hence the correct authentication information to the authentication unit assigned to the software component.

According to an embodiment, the default mode is enabled without authentication. In this embodiment, the default mode may be used without authentication, whereas the service mode involves authentication.

According to an embodiment, the authentication unit is also configured to enable the default mode on the basis of a piece of entered additional authentication information. In this embodiment, both default mode and service mode can involve authentication. In this case, the default mode is associated with a specific first piece of authentication information, for example a first password, whereas the service mode is associated with a specific second piece of authentication information, for example a second password. Using the first password, the user may then enable the use of the default mode, whereas the user may enable the service mode by entering the second password. In this context, it is possible by way of appropriate access control and associated password management to provide certain users with only the first password and certain other users with both passwords, i.e. the first password for the default mode and the second password for the service mode.

According to an embodiment, the software component is operable in a plurality of different service modes. In this context, each of the various service modes is assigned a respective set of the software functionalities, which is larger than the first set. In this embodiment, it is possible to provide different extended functionalities to different user groups by way of the use of different service modes.

According to an embodiment, each of the various service modes is associated with a respective piece of specific authentication information. In this context, the authentication unit is configured to enable a specific service mode of the various service modes on the basis of a piece of entered authentication information associated with the specific service mode. Each service mode is associated with a piece of specific authentication information, for instance a respective password. If the user enters the password associated with a specific service mode, then this assigned service mode of the software component is enabled for the user.

According to an embodiment, the system comprises a user interface. The user interface has at least one input mechanism which is configured for selecting the default mode or the at least one service mode. The input mechanism(s) of the user interface may comprise a keyboard, a different haptic input mechanism, such as a mouse, and/or a touch screen. The user interface accordingly allows the user to select the default mode or the service mode (or one of the service modes) and execute the service functionalities of the software component in the selected mode or cause the execution thereof by entering appropriate commands.

The user interface allows the user to select the appropriate mode of operation. It is furthermore conceivable that the switch from a service mode back to the default mode additionally occurs automatically after a certain time without user interaction. A time-out can be used to this end, and so the service mode is exited after a certain amount of time (e.g. one hour) has elapsed, and there is an automatic switch to the default mode.

According to an embodiment, the authentication information is in the form of a password, for example a static password or a time-dependent dynamic password.

According to an embodiment, the authentication information is formed as an activation key with a specific expiry time (for example a specific date, for instance Jan. 31, 2023), with a maximum use duration (for example one month) and/or with a maximum number of uses (for example five possible inputs).

According to an embodiment, the user interface is configured to send a request for transmitting the password to an authorization authority and in response to the sent request receive the password from the authorization authority and send the received password to the authentication unit. The authorization authority can be a server external to the lithography apparatus. This allows the authorization authority to manage the various pieces of authentication information, such as passwords. For example, the authorization authority can be operated by the manufacturer of the lithography apparatus. This further increases the protection of the lithography apparatus and the integrity of the software components.

According to an embodiment, the request sent by the user interface to the authorization authority comprises a piece of user-specific authorization information, which is associated with a user or a group of users and which determines specific access rights to the software component for a particular access class from a plurality of different access classes. As a result, different access classes may be defined for the software component. Each access class can be associated with specific access rights to the software component. The access classes may be hierarchical.

According to an embodiment, the first set of software functionalities, which can be executed in the default mode, comprises software functionalities for operating an optical system of the lithography apparatus.

According to an embodiment, the second set of software functionalities, which can be executed in the at least one service mode, comprises the software functionalities of the first set and, additionally, software functionalities directed to diagnostics and/or software functionalities directed to reparameterizations of the at least one actuator/sensor device.

According to an embodiment, the software component is configured in such a way that it provides multiple users with simultaneous access to their software functionalities by way of a plurality of parallel connections.

This makes it possible, and especially useful for system diagnostics, that the software component provides multiple users with simultaneous access to the software functionalities via parallel connections, for example parallel software connections. In this case, each of these connections is operable in default mode or in one of the service modes on an individual basis. During a system operation in default mode, an authorized user may be provided with extended system functionalities, e.g. for diagnostic purposes, without directly affecting the normal system operation. For example, this can help enable lithography apparatus diagnostics during the wafer exposure.

According to an embodiment, the system comprises a plurality N of electronics modules, where N≥2, and a central management unit The central management unit is configured to centrally manage user-specific access rights to the software components of the N electronics modules. In this embodiment, the user-dependent access control for all software components can be mapped centrally in the central management unit, which is realized as an overarching software component, for example.

According to an embodiment, the system comprises a plurality N of electronics modules, where N≥2. In this context, a respective decentralized management unit can be assigned to a respective electronics module of the N electronics modules. The decentralized management unit is configured to manage user-specific access rights to the software components of the assigned electronics module. The respective decentralized management unit is assigned to the respective software component and may manage the access rights and access restrictions to the assigned software component on an individual basis.

According to an embodiment, the electronics module is arranged within the vacuum housing of the lithography apparatus. In this case, the electronics module is for example part of the external controller of the lithography apparatus, which is for example arranged in a gray room or in a clean room external to the vacuum housing of the lithography apparatus.

According to an embodiment, the system comprises a plurality N of electronics modules, where N≥2, wherein a first subset of the plurality N is arranged in a vacuum housing of the lithography apparatus and a second subset of the plurality N is arranged outside the vacuum housing of the lithography apparatus, for example as part of an external controller. In this embodiment, some of the electronics modules can be part of the lithography apparatus and other electronics modules are part of the external controller of the lithography apparatus.

According to an embodiment, the electronics module is arranged outside the vacuum housing of the lithography apparatus, for example as part of an external controller, and configured to control a driver unit that is arranged in the vacuum housing and assigned to an actuator/sensor device of the lithography apparatus and a data memory that is assigned to the driver unit. The driver unit is configured to drive the at least one assigned actuator/sensor device. In this case, the driver unit is coupled to the electronics module via at least one electrical connection and a vacuum feedthrough. Furthermore, the electronics module is also configured to control the data memory assigned to the driver unit, for example to execute read commands and/or write commands on the data memory.

According to an embodiment, the electronics module is arranged outside the vacuum housing of the lithography apparatus, for example as part of an external controller, and configured to control a driver unit that is arranged outside the vacuum housing and assigned to an actuator/sensor device of the optical system of the lithography apparatus arranged in the vacuum housing and a data memory that is assigned to the driver unit. In this embodiment, the driver unit is also arranged external to the vacuum housing. In that case, the driver unit is coupled to the assigned actuator/sensor device via at least one electrical connection and a vacuum feedthrough.

According to an embodiment, the vacuum housing is designed for a pressure of 1013.25 hPa to 10⁻³ hPa or a pressure of 10⁻³ to 10⁻⁸ hPa or a pressure of 10⁻⁸ to 10⁻¹¹ hPa in its interior.

According to an embodiment, the N electronics modules are part of an optical system of the lithography apparatus.

According to an embodiment, the optical system takes the form of an illumination optics unit or the form of a projection optics unit of a lithography apparatus.

The respective unit, for example the authentication unit, may be implemented in hardware and/or software. In the case of a hardware implementation, the unit can be in the form of a device or part of a device, for example a computer or a microprocessor or part of the controller. In the case of a software implementation, the unit can be in the form of a computer program product, a function, a routine, part of a program code or an executable object.

According to a second aspect, a lithography apparatus is proposed, having a number N of electronics modules for a number of actuator/sensor devices of the lithography apparatus, where N≥1. In this case, the electronics module comprises a software component with a plurality of software functionalities, wherein the software component is operable in a plurality of different modes of operation at least comprising a default mode and at least one service mode, wherein a first set of the software functionalities, which is formed as a subset, can be executed in the default mode and a second set of the software functionalities, which is larger than the first set, can be executed in the service mode.

The embodiments described for the first aspect apply accordingly to the proposed lithography apparatus according to the second aspect. Furthermore, the definitions and explanations given in relation to the system also apply accordingly to the proposed lithography apparatus.

According to a third aspect, a method is proposed for operating a system having a lithography apparatus and a number N of electronics modules for a number of actuator/sensor devices of the lithography apparatus, where N≥1. In this context, the electronics module is equipped with a software component, which comprises a plurality of software functionalities for the lithography apparatus and is operable in a plurality of different modes of operation at least comprising a default mode and at least one service mode, wherein a first set of the software functionalities, which is formed as a subset, can be executed in the default mode and a second set of the software functionalities, which is larger than the first set, can be executed in the service mode.

The embodiments described for the proposed system according to the first aspect apply accordingly to the proposed method according to the third aspect. Furthermore, the definitions and explanations given in relation to the system also apply accordingly to the proposed method.

“A” or “an” in the present context should not necessarily be regarded as a restriction to exactly one element. Instead, multiple elements, for example two, three or more, may also be provided. Any other numeral used here should also not be understood as a restriction to exactly the stated number of elements. Rather, numerical deviations upward and downward are possible, unless indicated otherwise.

Further possible implementations of the disclosure also comprise combinations not explicitly mentioned of features or embodiments which were described previously or are described in the following text in relation to the exemplary embodiments. A person skilled in the art will also add individual aspects as improvements or supplementations to the respective basic form of the disclosure.

Further configurations and aspects of the disclosure are the subject of the claims and of the exemplary embodiments of the disclosure that are described hereinafter.

### BRIEF DESCRIPTION OF THE DRAWINGS

The disclosure is explained in greater detail hereinafter on the basis of certain embodiments with reference to the appended figures.

FIG. 1 shows a schematic meridional section of a projection exposure apparatus for EUV projection lithography.

FIG. 2 shows a schematic view of an embodiment of a system having a lithography apparatus and a number of electronics modules.

FIG. 3 shows a schematic view of an embodiment of a system having a lithography apparatus and a number of electronics modules.

FIG. 4 shows a schematic view of an embodiment of a system having a lithography apparatus and a number of electronics modules.

FIG. 5 shows a schematic view of an embodiment of a system having a lithography apparatus and a number of electronics modules.

FIG. 6 shows a schematic view of an embodiment of a system having a lithography apparatus and a number of electronics modules.

FIG. 7 shows a schematic view of an embodiment of a system having a lithography apparatus and a number of electronics modules.

FIG. 8 shows one embodiment of a method for operating a lithography apparatus.

### DETAILED DESCRIPTION

In the figures, identical or functionally identical elements have been provided with the same reference signs, unless indicated otherwise. Furthermore, it should be noted that the illustrations in the figures are not necessarily true to scale.

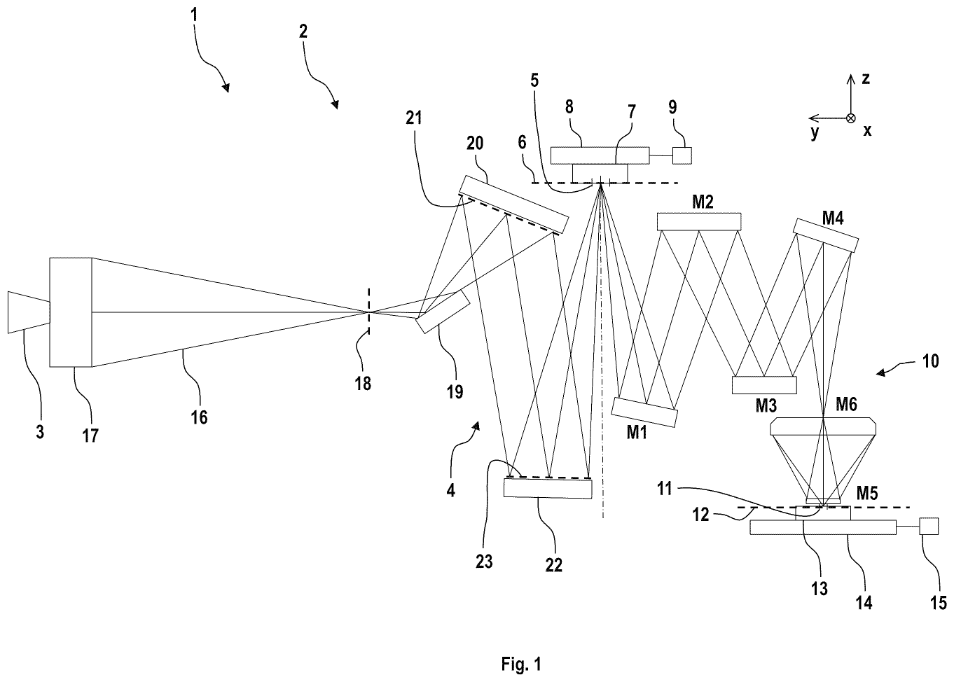

FIG. 1 shows one embodiment of a projection exposure apparatus 1 (lithography apparatus), for example an EUV lithography apparatus. One design of an illumination system 2 of the projection exposure apparatus 1 has, in addition to a light or radiation source 3, an illumination optics unit 4 for illuminating an object field 5 in an object plane 6. In an alternative embodiment, the light source 3 may also be provided as a module separate from the rest of the illumination system 2. In this case, the illumination system 2 does not comprise the light source 3.

A reticle 7 arranged in the object field 5 is exposed. The reticle 7 is held by a reticle holder 8. The reticle holder 8 is displaceable by way of a reticle displacement drive 9, for example in a scanning direction.

FIG. 1 depicts, for explanation purposes, a Cartesian coordinate system with an x-direction x, a y-direction y, and a z-direction z. The x-direction x runs perpendicularly into the plane of the drawing. The y-direction y runs horizontally, and the z-direction z runs vertically. The scanning direction runs in the y-direction y in FIG. 1. The z-direction z runs perpendicularly to the object plane 6.

The projection exposure apparatus 1 comprises a projection optics unit 10. The projection optics unit 10 serves to image the object field 5 into an image field 11 in an image plane 12. The image plane 12 extends parallel to the object plane 6. In an alternative, an angle that differs from 0° is also possible between the object plane 6 and the image plane 12.

A structure on the reticle 7 is imaged onto a light-sensitive layer of a wafer 13 arranged in the region of the image field 11 in the image plane 12. The wafer 13 is held by a wafer holder 14. The wafer holder 14 is displaceable by way of a wafer displacement drive 15, for example in the y-direction y. The displacement, firstly, of the reticle 7 by way of the reticle displacement drive 9 and, secondly, of the wafer 13 by way of the wafer displacement drive 15 may be mutually synchronized.

The light source 3 is an EUV radiation source. The light source 3 emits for example EUV radiation 16, which is also referred to below as used radiation, illumination radiation or illumination light. The used radiation 16 has for example a wavelength in the range of between 5 nm and 30 nm. The light source 3 may be a plasma source, for example an LPP (laser produced plasma) source or a GDPP (gas discharge produced plasma) source. It may also be a synchrotron-based radiation source. The light source 3 may be a free electron laser (FEL).

The illumination radiation 16 emanating from the light source 3 is focused by a collector 17. The collector 17 may be a collector having one or more ellipsoidal and/or hyperboloidal reflection surfaces. The illumination radiation 16 may be incident on the at least one reflection surface of the collector 17 with grazing incidence (GI), i.e. at angles of incidence of greater than 45°, or with normal incidence (NI), i.e. at angles of incidence of less than 45°. The collector 17 may be structured and/or coated on the one hand for optimizing its reflectivity for the used radiation and on the other hand for suppressing extraneous light.

Downstream of the collector 17, the illumination radiation 16 propagates through an intermediate focus in an intermediate focal plane 18. The intermediate focal plane 18 may represent a separation between a radiation source module, comprising the light source 3 and the collector 17, and the illumination optics unit 4.

The illumination optics unit 4 comprises a deflection mirror 19 and, disposed downstream thereof in the beam path, a first facet mirror 20. The deflection mirror 19 may be a planar deflection mirror or, alternatively, a mirror with a beam-influencing effect that goes beyond the purely deflecting effect. In an alternative to that or in addition, the deflection mirror 19 may be in the form of a spectral filter that separates a used light wavelength of the illumination radiation 16 from extraneous light of a wavelength deviating therefrom. Should the first facet mirror 20 be arranged in a plane of the illumination optics unit 4 which is optically conjugate to the object plane 6 as a field plane, this facet mirror is also referred to as a field facet mirror. The first facet mirror 20 comprises a multiplicity of individual first facets 21, which may also be referred to as field facets. Only some of these first facets 21 are illustrated in FIG. 1 by way of example.

The first facets 21 may be embodied as macroscopic facets, for example as rectangular facets or as facets with an arcuate or an edge contour of part of a circle. The first facets 21 may take the form of plane facets or, in an alternative to that, convexly or concavely curved facets.

As is known for example from DE 10 2008 009 600 A1, the first facets 21 themselves may each also be composed of a multiplicity of individual mirrors, for example a multiplicity of micromirrors. The first facet mirror 20 may take the form of a microelectromechanical system (MEMS system) for example. For details, reference is made to DE 10 2008 009 600 A1.

The illumination radiation 16 travels horizontally, i.e. in the y-direction y, between the collector 17 and the deflection mirror 19.

In the beam path of the illumination optics unit 4, a second facet mirror 22 is disposed downstream of the first facet mirror 20. If the second facet mirror 22 is disposed in a pupil plane of the illumination optics unit 4, it is also referred to as a pupil facet mirror. The second facet mirror 22 may also be spaced apart from a pupil plane of the illumination optics unit 4. In this case, the combination of the first facet mirror 20 and the second facet mirror 22 is also referred to as a specular reflector. Specular reflectors are known from US 2006/0132747 A1, EP 1 614 008 B1 and U.S. Pat. No. 6,573,978.

The second facet mirror 22 comprises a plurality of second facets 23. In the case of a pupil facet mirror, the second facets 23 are also referred to as pupil facets.

The second facets 23 may likewise be macroscopic facets, which can for example have a round, rectangular or else hexagonal boundary, or can alternatively be facets composed of micromirrors. For details in this regard, reference is likewise made to DE 10 2008 009 600 A1.

The second facets 23 may have plane or, alternatively, convexly or concavely curved reflection surfaces.

The illumination optics unit 4 thus forms a doubly faceted system. This fundamental principle is also referred to as a fly's eye integrator.

It may be desirable to arrange the second facet mirror 22 not exactly in a plane that is optically conjugate to a pupil plane of the projection optics unit 10. For example, the second facet mirror 22 may can be arranged so as to be tilted in relation to a pupil plane of the projection optics unit 10, as described for example in DE 10 2017 220 586 A1.

The individual first facets 21 are imaged into the object field 5 with the aid of the second facet mirror 22. The second facet mirror 22 is the last beam-shaping mirror or else actually the last mirror for the illumination radiation 16 in the beam path upstream of the object field 5.

In a further embodiment (not illustrated) of the illumination optics unit 4, a transfer optics unit contributing for example to the imaging of the first facets 21 into the object field 5 may be arranged in the beam path between the second facet mirror 22 and the object field 5. The transfer optics unit may have exactly one mirror or alternatively two or more mirrors, which are arranged one behind another in the beam path of the illumination optics unit 4. The transfer optics unit may for example comprise one or two normal-incidence mirrors (NI mirrors) and/or one or two grazing-incidence mirrors (GI mirrors).

In the embodiment shown in FIG. 1, the illumination optics unit 4 has exactly three mirrors downstream of the collector 17, specifically the deflection mirror 19, the first facet mirror 20 and the second facet mirror 22.

In a further embodiment of the illumination optics unit 4, the deflection mirror 19 may also be omitted, and so the illumination optics unit 4 can then have exactly two mirrors downstream of the collector 17, specifically the first facet mirror 20 and the second facet mirror 22.

The imaging of the first facets 21 into the object plane 6 via the second facets 23 or using the second facets 23 and a transfer optics unit is often only approximate imaging.

The projection optics unit 10 comprises a plurality of mirrors Mi, which are consecutively numbered in accordance with their arrangement in the beam path of the projection exposure apparatus 1.

In the example illustrated in FIG. 1, the projection optics unit 10 comprises six mirrors M1 to M6. Alternatives with four, eight, ten, twelve or a different number of mirrors Mi are also possible. The projection optics unit 10 is a doubly obscured optics unit. The penultimate mirror M5 and the last mirror M6 each have a passage opening for the illumination radiation 16. The projection optics unit 10 has an image-side numerical aperture that is greater than 0.5 and may also be greater than 0.6 and, for example, may be 0.7 or 0.75.

Reflection surfaces of the mirrors Mi may take the form of free-form surfaces without an axis of rotational symmetry. Alternatively, the reflection surfaces of the mirrors Mi may be designed as aspherical surfaces with exactly one axis of rotational symmetry of the reflection surface shape. Just like the mirrors of the illumination optics unit 4, the mirrors Mi may have highly reflective coatings for the illumination radiation 16. These coatings may be designed as multilayer coatings, for example with alternating layers of molybdenum and silicon.

The projection optics unit 10 has a large object-image shift in the y-direction y between a y coordinate of a center of the object field 5 and a y coordinate of the center of the image field 11. This object-image shift in the y-direction y may be of approximately the same magnitude as a z-distance between the object plane 6 and the image plane 12.

The projection optics unit 10 may for example have an anamorphic form. For example, it has different imaging scales βx, βy in the x- and y-directions x, y. The two imaging scales βx, βy of the projection optics unit 10 are preferably (βx, βy)=(+/−0.25, +/−0.125). A positive imaging scale β means imaging without image inversion. A negative sign for the imaging scale β means imaging with image inversion.

The projection optics unit 10 consequently leads to a reduction in size with a ratio of 4:1 in the x-direction x, i.e. in a direction perpendicular to the scanning direction.

The projection optics unit 10 leads to a reduction in size of 8:1 in the y-direction y, i.e. in the scanning direction.

Other imaging scales are likewise possible. Imaging scales with the same sign and the same absolute value in the x-direction x and y-direction y are also possible, for example with absolute values of 0.125 or of 0.25.

The number of intermediate image planes in x-direction x and in y-direction y in the beam path between the object field 5 and the image field 11 can be the same or can be different, depending on the design of the projection optics unit 10. Examples of projection optics units with different numbers of such intermediate images in x-direction x and y-direction y are known from US 2018/0074303 A1.

One of the second facets 23 in each case is associated with exactly one of the first facets 21 for formation of a respective illumination channel for illumination of the object field 5. This may for example produce illumination according to the Köhler principle. The far field is decomposed into a multiplicity of object fields 5 with the aid of the first facets 21. The first facets 21 create a plurality of images of the intermediate focus on the second facets 23 respectively assigned thereto.

By way of an assigned second facet 23, the first facets 21 are each imaged onto the reticle 7 and overlaid on one another for the purpose of illuminating the object field 5. The illumination of the object field 5 is for example of maximum homogeneity. It preferably has a uniformity error of less than 2%. Field uniformity may be achieved by overlaying different illumination channels.

The illumination of the entrance pupil of the projection optics unit 10 may be defined geometrically by an arrangement of the second facets 23. By selection of the illumination channels, for example the subset of the second facets 23 that guide light, it is possible to adjust the intensity distribution in the entrance pupil of the projection optics unit 10. This intensity distribution is also referred to as illumination setting or illumination pupil filling.

A likewise preferred pupil uniformity in the region of portions of an illumination pupil of the illumination optics unit 4 that are illuminated in a defined manner can be achieved by a redistribution of the illumination channels.

Further aspects and details of the illumination of the object field 5 and, for example, of the entrance pupil of the projection optics unit 10 are described below.

The projection optics unit 10 may have a homocentric entrance pupil, for example. The latter may be accessible. It may also be inaccessible.

The entrance pupil of the projection optics unit 10 regularly cannot be exactly illuminated with the second facet mirror 22. In the case of imaging by the projection optics unit 10 which telecentrically images the center of the second facet mirror 22 onto the wafer 13, the aperture rays often do not intersect at a single point. However, it is possible to find an area in which the spacing of the aperture rays that is determined in pairs becomes minimal. This area represents the entrance pupil or an area conjugate thereto in real space. For example, this area exhibits a finite curvature.

It may be the case that the projection optics unit 10 has different positions of the entrance pupil for the tangential beam path and for the sagittal beam path. In this case, an imaging element, for example an optical component part of the transfer optics unit, should be provided between the second facet mirror 22 and the reticle 7. With the aid of this optical element, the different position of the tangential entrance pupil and of the sagittal entrance pupil can be taken into account.

In the arrangement of the components of the illumination optics unit 4 shown in FIG. 1, the second facet mirror 22 is arranged in an area conjugate to the entrance pupil of the projection optics unit 10. The first facet mirror 20 is arranged so as to be tilted with respect to the object plane 6. The first facet mirror 20 is arranged so as to be tilted with respect to an arrangement plane defined by the deflection mirror 19. The first facet mirror 20 is arranged so as to be tilted with respect to an arrangement plane defined by the second facet mirror 22.

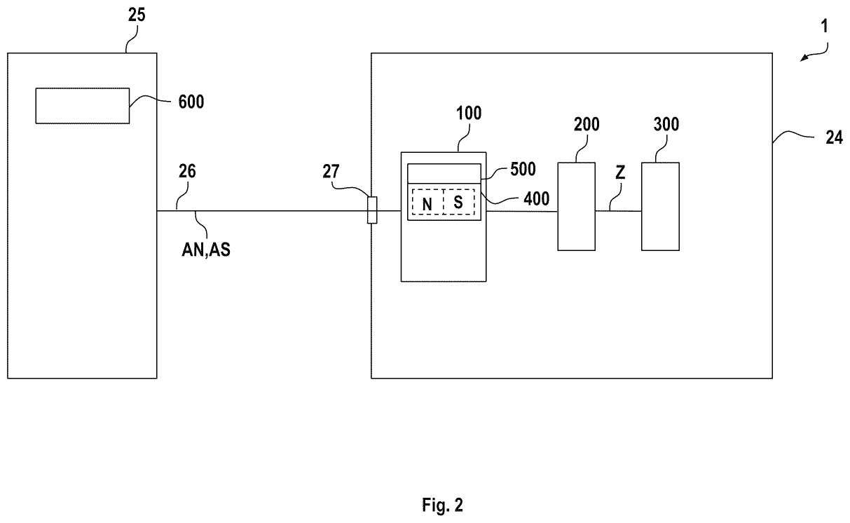

FIG. 2 shows a schematic view of a first embodiment of a system having a lithography apparatus 1, for example as shown in FIG. 1, and a number of electronics modules 100.

Without loss of generality, the first embodiment according to FIG. 2 has an electronics module 100. The electronics module 100 is configured to control an actuator/sensor device 200. The actuator/sensor device 200 is assigned to an optical element 300. In FIG. 2, this assignment is illustrated by reference sign Z. The electronics module 100, the actuator/sensor device 200 and the optical element 300 are arranged in vacuo in a vacuum housing 24 of the lithography apparatus 1.

Furthermore, the system of FIG. 2 comprises a controller 25 arranged external to the vacuum housing 24. The controller 25 is coupled via at least one electrical connection 26 and at least one vacuum feedthrough 27 to the electronics module 100 arranged in the vacuum housing 24. Data and energy can be transmitted via the at least one electrical connection 26. Thus, the electronics module 100, which is arranged in the vacuum housing 24, can exchange data with the external controller 25 via the at least one electrical connection 26 and the vacuum feedthrough 27. Furthermore, the electronics module 100 can be supplied with electrical energy via the at least one electrical connection 26 and the vacuum feedthrough 27.

The electronics module 100 is configured for example to control the actuator/sensor device 200 of the lithography apparatus 1. For this purpose, the electronics module 100 is implemented in hardware for example. If the implementation is in hardware, the electronics module 100 can be embodied as a device or as part of a device, for example as a computer or as a microprocessor or as a control computer or as an embedded system.

The control data for controlling the actuator/sensor device 200 are transmitted for example from the external controller 25 in the form of electrical signals via the at least one electrical connection 26 and the vacuum feedthrough 27 to the electronics module 100. The term “electrical signals” is understood here to mean both digital and analog electrical signals, wherein an operating voltage by way of which electrical energy is provided for the operation of the illumination system 2 and/or the electronics unit 100, for example, also constitutes an electrical signal. The electrical signal may for example comprise a data signal, which may comprise a control signal for controlling the actuator/sensor device 200 or else a measurement data signal from the actuator/sensor device 200.

The electrical connection 26 may be in the form of a wired interface for example. The term “interface” is understood here for example to mean the entire signal transmission path from the external controller 25 to the electronics module 100.

In this case, the interface comprises a number of cable bundles, plug connectors and the like. The interface may have a multiplicity of electrical lines running in parallel along its course. In some embodiments, the interface may however also comprise, in sections, a different multiplicity of electrical lines running in parallel; for example, an individual operating voltage line in a plug connector may be placed onto a multiplicity of contact pins of the plug connector. The interface comprises, in sections, for example up to 100 parallel electrical lines, or up to 400 parallel electrical lines, or even up to 1000 parallel electrical lines.

The electronics module 100 comprises a software component 400 with a plurality of software functionalities. The software component 400 is operable in a plurality of different modes of operation N, S at least comprising a default mode N and at least one service mode S. The default mode N may also be referred to as normal mode.

In default mode N, a first set of software functionalities, which is in the form of a subset (proper subset), can be executed. A second set of software functionalities, which is larger than the first set, can be executed in the service mode S. The first set of software functionalities, which can be executed in the default mode N, comprises software functionalities for operating the lithography apparatus 1. For example, these software functionalities of the first set comprise those for controlling the actuator/sensor device 200, by which, in turn, the optical element 300 can be controlled.

The second set of software functionalities, which can be executed in the service mode S, comprises the service functionalities of the first set and, additionally, software functionalities directed to diagnostics and/or software functionalities directed to reparameterizations of the actuator/sensor device 200.

As illustrated in FIG. 2, provision is made for an authentication unit 500 that is assigned to the software component 400. The authentication unit 500 is configured to enable the service mode S on the basis of a piece of entered authentication information AS. The authentication information AS is associated with service mode S and is only suitable for enabling service mode S. For example, the default mode N is enabled without authentication. In embodiments, however, a piece of authentication information AN associated with the default mode N might also be used to enable the default mode N. In the latter case, the authentication unit 500 is also configured to enable the default mode N on the basis of the entered authentication information AN.

As also illustrated in FIG. 2, the system may comprise a user interface 600. Without loss of generality, the user interface 600 according to FIG. 2 is embodied as part of the external controller 25. The user interface 600 comprises at least one input mechanism which is configured for selecting the default mode N and the at least one service mode S. Thus, using the user interface 600, the user is able choose whether they want to operate the software component 400 in the default mode N or in the service mode S. If the user selects the default mode N for operating the software component 400, they initiate the transmission via the user interface 600 and the external controller 25 of the authentication information AN associated with the default mode N to the authentication unit 500 assigned to the service component 400. The authentication unit 500 authenticates the transmitted authentication information AN and, in the event of a positive authentication result, enables the default mode N of software component 400 for the user.

However, if the user chooses the service mode S, the authentication information AS associated with the service mode S is transmitted via the user interface 600 and via the external controller 25 to the authentication unit 500 assigned to the software component 400. In that case, the authentication unit 500 authenticates the transmitted authentication information AS and, in the event of a successful authentication, enables the service mode S of service component 400 for the user.

The aforementioned input mechanism(s) of the user interface 600 may comprise a keyboard, a different haptic input mechanism, such as a mouse, and/or a touch screen. In embodiments, a voice input as input mechanism is also possible.

The respective authentication information AN or AS may be in the form of a password, for example a static password or a time-dependent dynamic password. In embodiments, the respective authentication information AN or AS may be formed as an activation key with a specific expiry time (for example a specific date, for instance Dec. 31, 2022), with a maximum use duration (for example two weeks) and/or with a maximum number of uses (for example ten possible inputs).

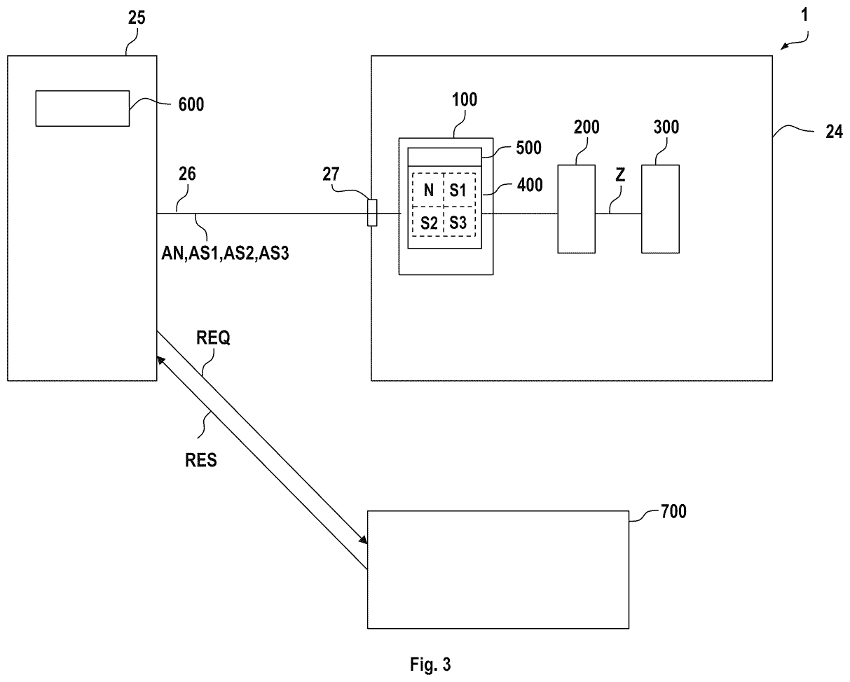

FIG. 3 shows a schematic view of a second embodiment of a system having a lithography apparatus 1, for example as shown in FIG. 1, and a number of electronics modules 100. The second embodiment according to FIG. 3 is based on the first embodiment according to FIG. 2.

In contrast with the first embodiment according to FIG. 2, the software component 400 according to FIG. 3 is operable not in a single service mode only but in three different service modes S1, S2, S3. Each of the various service modes S1, S2, S3 is associated with a respective set of software functionalities, wherein the respective associated set is larger than the first set of software functionalities, which is associated with default mode N.

The respective service modes S1, S2, S3 is associated with a respective piece of specific authentication information AS1, AS2, AS3. For example, the first service mode AS1 can be enabled by way of the authentication information AS1. In an analogous manner, the second service mode S12 can be enabled by way of the authentication information AS2, and the third service mode S3 can be enabled by way of the authentication information AS3. In this case, the authentication unit 500 is configured to enable a specific service mode S1, S2, S3 of the various service modes S1, S2, S3 on the basis of a piece of entered authentication information AS1, AS2, AS3 associated with the specific service mode S1, S2, S3. For example, if the user enters the authentication information AS2, then the authentication unit 500 can enable service mode S2, which is associated with the authentication information AS2.

As also illustrated in FIG. 3, the system may also comprise an external server 700. The server 700 may comprise or form an authorization authority that manages the authentication information AN, AS1, AS2, AS3.

In this case, the user interface 600 may also be configured to send a request REQ for transmitting a specific piece of authentication information of the authentication information AN, AS1, AS2, AS3 to the server 700 following an appropriate input by the user and in response RES to the sent request REQ receive the specific authentication information AN, AS1, AS2, AS3 from server 700 and send the received specific authentication information AN, AS1, AS2, AS3 to authentication unit 500. To this end, the request REQ sent by the user interface 600 to the server 700 may comprise a piece of user-specific authorization information, which is associated with a user or a group of users and which determines specific access rights to the software component 400 for a particular access class from a plurality of different access classes. As a result, different access classes may be defined for the software component 400. Each access class is associated with specific access rights to the software component 400. The access classes may be hierarchical.

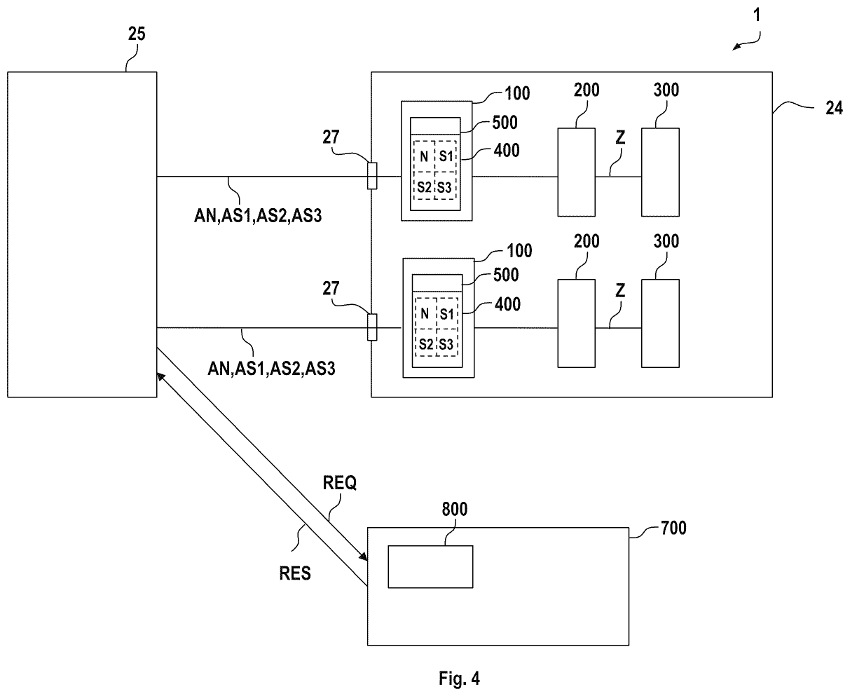

FIG. 4 shows a schematic view of a third embodiment of a system having a lithography apparatus 1, for example as shown in FIG. 1, and a number of electronics modules 100.

The third embodiment according to FIG. 4 is based on the second embodiment according to FIG. 3 and differs from the latter in that the system of FIG. 4 comprises a plurality N of electronics modules 100. Without loss of generality, the plurality N of electronics modules 100 is equal to two in FIG. 4 (N=2). Moreover—without loss of generality—both electronics modules 100 are arranged in the vacuum housing 24 of the lithography apparatus 1. In embodiments, one subset of the plurality N of electronics modules 100 is arranged in the vacuum housing 24 and another subset of the plurality N of electronics modules 100 is arranged outside the vacuum housing 24, for example as part of the external controller 25. For the example of two electronics modules 100, one of the electronics modules may be formed as part of the controller 25, and the other electronics module 100 may be arranged in the vacuum housing 24 (not shown). In embodiments, both electronics modules 100 might also be formed as part of the external controller 25 (not shown).

Furthermore, FIG. 4 shows that the system may comprise a central management unit 800. Without loss of generality, the central management unit 800 according to FIG. 4 is part of the server 700. The central management unit 800 is configured to centrally manage user-specific access rights to the software components 400 of the plurality N of electronics modules 100.

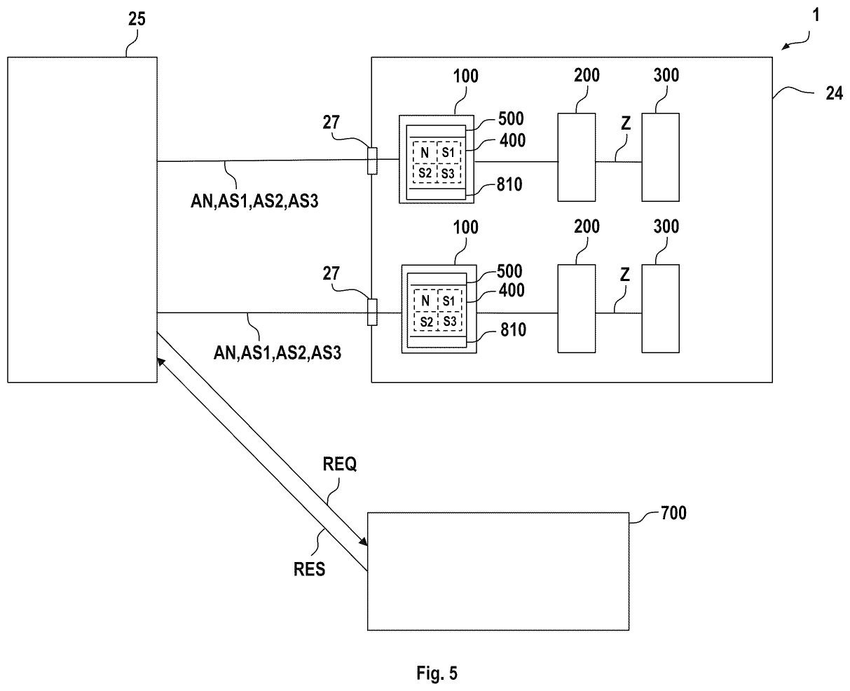

FIG. 5 shows a schematic view of a fourth embodiment of a system having a lithography apparatus 1, for example as depicted in FIG. 1, and a number of electronics modules 100.

The fourth embodiment according to FIG. 5 differs from the third embodiment according to FIG. 4 in that the system according to FIG. 5 does not use a central management unit for managing the access rights to the software components 400 but uses respective dedicated decentralized management units 810 instead. Thus, each of the electronics modules 100 is assigned a respective decentralized management unit 810, which is configured to manage the user-specific access rights to the associated software component 400. In embodiments, the decentralized management unit 810 may also be formed as part of the authentication unit 500.

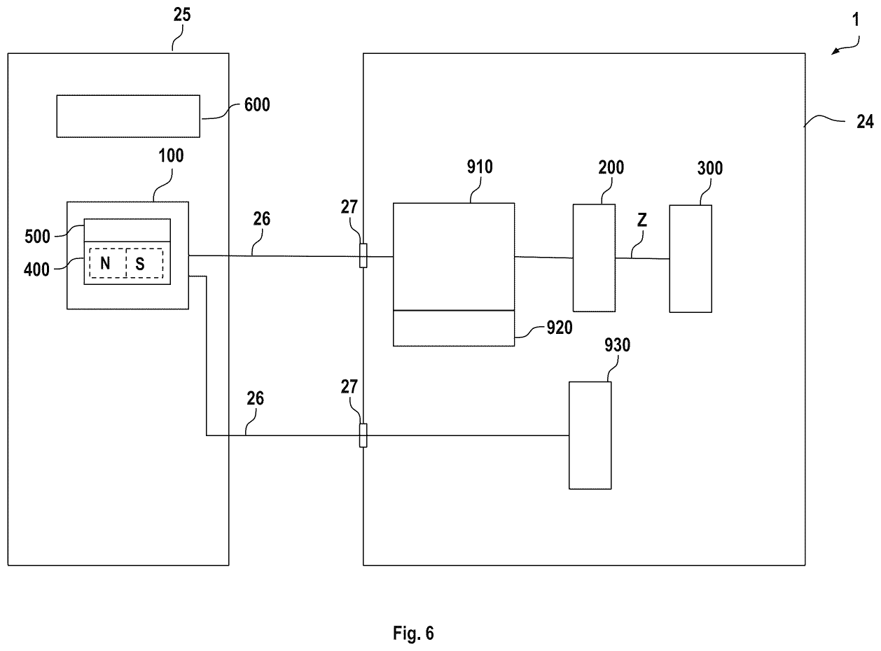

FIG. 6 shows a schematic view of a fifth embodiment of a system having a lithography apparatus 1, for example as shown in FIG. 1, and a number of electronics modules 100. Without loss of generality, the system according to FIG. 6 has an electronics module 100, which is arranged external to the vacuum housing 24 of the lithography apparatus 1 and, in the example of FIG. 6, is formed as part of the external controller 25. To control the actuator/sensor device 200, the system of FIG. 6 has a driver unit 910, which is arranged in the vacuum housing 24 and is disposed upstream of the actuator/sensor device 200. The driver unit 910, which is arranged external to the vacuum housing 24 and assigned to the actuator/sensor device 200 of the lithography apparatus 1, is designed to drive the actuator/sensor device 200. The driver unit 910 is coupled via at least one electrical connection 26 and a vacuum feedthrough 27 to the electronics module 100. Furthermore, in the system of FIG. 6, provision is made for a data memory 920 which is assigned to the driver unit 910. The electronics module 100 of FIG. 6 is also configured to control the data memory 910 assigned to the driver unit 910, for example to execute read commands and/or write commands on the data memory 920.

Furthermore, FIG. 6 illustrates that the electronics module 100 is connected via an electrical connection 26 and a vacuum feedthrough 27 to a sensor 930, which is arranged within the vacuum housing 24 of the lithography apparatus 1. For example, the sensor 930 is a temperature sensor. The electronics module 100 may for example control the sensor 930 and/or receive data therefrom.

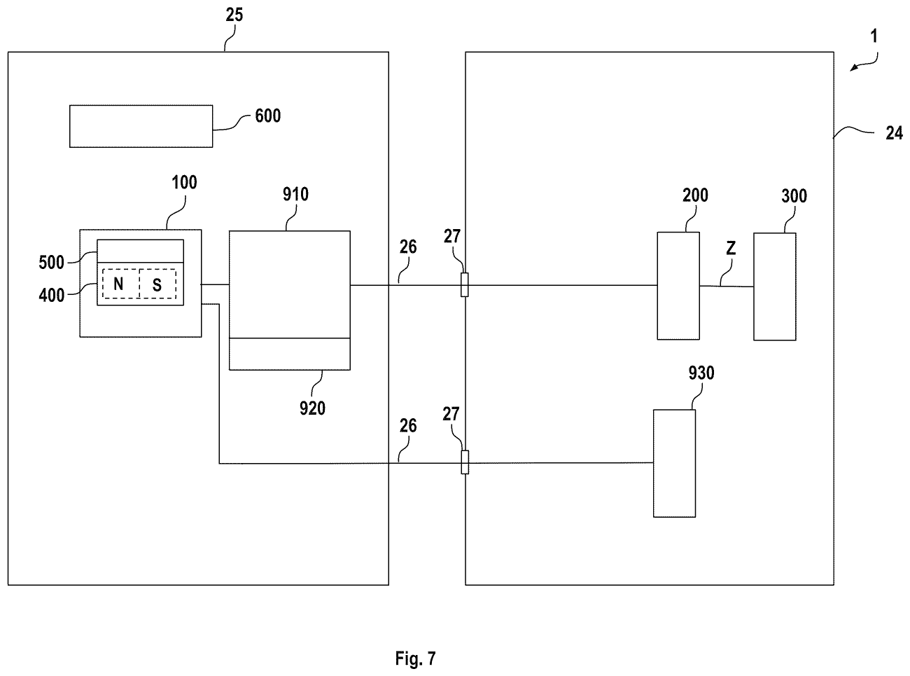

FIG. 7 shows a schematic view of a sixth embodiment of a system having a lithography apparatus 1, for example as shown in FIG. 1, and a number of electronics modules 100. The sixth embodiment according to FIG. 7 is based on the fifth embodiment according to FIG. 6 and differs from the latter in that, in the system of FIG. 7, the driver unit 910 and the data memory 920 assigned to the driver unit 910 are not formed in the vacuum housing 24 but external to the vacuum housing 24 as part of the controller 25.

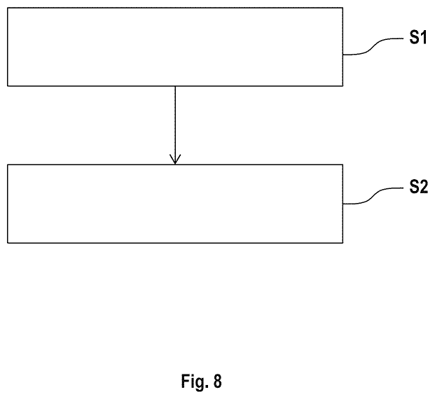

FIG. 8 depicts a method for operating a system having a lithography apparatus 1 and a number of N of electronics modules 100 for a number of actuator/sensor devices 200 of the lithography apparatus 1. Examples of such systems are shown in FIGS. 2 to 7.

The method according to FIG. 8 comprises the steps S1 and S2:

In step S1, the electronics module 100 is equipped with a software component 400, which comprises a plurality of software functionalities for the lithography apparatus 1 and is operable in a plurality of different modes of operation N, S, S1, S2, S3 at least comprising a default mode N and at least one service mode S, S1, S2, S3. A first set of software functionalities, which is formed as a subset, can be executed by the software component 400 in the default mode N. A second set of software functionalities, which is larger than the first set, can be executed by the software component 400 in the service mode S, S2, S3, S4.

In step S2, a user selects the default mode N or the at least one service mode S, S1, S2, S3, and, depending on commands entered by the user, the software functionalities of the chosen mode of operation N or S, S1, S2, S3 are executed.

Although the present disclosure has been described on the basis of exemplary embodiments, it is modifiable in diverse ways.

### LIST OF REFERENCE SIGNS

1 Projection exposure apparatus
2 Illumination system
3 Light source
4 Illumination optics unit
5 Object field
6 Object plane
7 Reticle
8 Reticle holder
9 Reticle displacement drive
10 Projection optics unit
11 Image field
12 Image plane
13 Wafer
14 Wafer holder
15 Wafer displacement drive
16 Illumination radiation
17 Collector
18 Intermediate focal plane
19 Deflection mirror
20 First facet mirror
21 First facet
22 Second facet mirror
23 Second facet
24 Vacuum housing
25 Controller
26 Electrical connection
27 Vacuum feedthrough
100 Electronics module
200 Actuator/sensor device
300 Optical element
400 Software component
500 Authentication unit
600 User interface
700 Server, authorization authority
800 Central management unit
810 Decentralized management unit
910 Driver unit
920 Memory unit
930 Sensor
AS Authentication information for a service mode
AS1 Authentication information for a first service mode
AS2 Authentication information for a second service mode
AS3 Authentication information for a third service mode
AN Authentication information for a default mode
N Default mode
REQ Request
RES Response
S Service mode
Z Assignment

What is claimed is:

1. A system, comprising:
a lithography apparatus, comprising:
at least one actuator/sensor device;
at least one electronics module configured to control the at least one actuator/sensor device,
wherein:
the electronics module comprises a software component with a plurality of software functionalities;
the software component is operable in a plurality of different modes of operation which comprise a default mode and a service mode;
a first set of the software functionalities, which is a subset, is executable in the default mode; and
a second set of the software functionalities, which is larger than the first set, can be executed in the service mode.

2. The system of claim 1, further comprising an authentication unit assigned to the software component, wherein the authentication unit is configured to enable the service mode based on authentication information.

3. The system of claim 2, wherein the system is configured so that the default mode is always enabled.

4. The system of claim 2, wherein the authentication unit is configured to enable the default mode based on multiple different pieces of authentication information.

5. The system of claim 2, wherein:
the software component is operable in a plurality of different service modes;
each of the various service modes is assigned a respective set of the software functionalities which is larger than the first set;
each of the various service modes is associated with a respective piece of specific authentication information; and
the authentication unit is configured to enable a specific service mode of the various service modes based on a piece of entered authentication information associated with the specific service mode.

6. The system of claim 2, wherein the authentication information comprises a password, an activation key with an expiry time, a maximum use duration and/or a maximum number of uses.

7. The system of claim 2, wherein:
the authentication information comprises a password; and
the system further comprises a user interface is configured to;
i) send a request to transmit the password to an authorization authority;
ii) in response to the sent request, receive the password from the authorization authority; and
iii) send the received password to the authentication unit.

8. The system of claim 7, wherein the request comprises user-specific authorization information associated with a user or a group of users, and the request is configured to determine specific access rights to the software component for an access class from a plurality of different access classes.

9. The system of claim 1, wherein the software component is operable in a plurality of different service modes, each of the various service modes is assigned a respective set of the software functionalities which is larger than the first set.

10. The system of claim 1, further comprising a user interface comprising at least one input mechanism configured to select the at least one default mode or the at least one service mode.

11. The system of claim 1, wherein:
the lithography apparatus comprises an optical system;
the first set of software functionalities comprises software functionalities to operate the optical system;
the second set of software functionalities comprises the software functionalities of the first set of software functionalities; and
the second set of software functionalities comprises software functionalities directed to diagnostics and/or software functionalities directed to reparameterizations of the at least one actuator/sensor device.

12. The system of claim 1, wherein the software component is configured to provide multiple users with simultaneous access to software functionalities by way of a plurality of parallel connections.

13. The system of claim 1, wherein:
the at least one electronics module comprises at least two electronics modules; and
the system further comprises a central management unit configured to centrally manage user-specific access rights to the software components of the at least two electronics modules.

14. The system of claim 1, wherein:
the at least one electronics module comprises first and electronics modules; and
the system further comprises first and second decentralized management units;
the first decentralized management unit is configured to manage user-specific access rights to the software components of the first electronics module; and
the second decentralized management unit is configured to manage user-specific access rights to the software components of the second electronics module.

15. The system of claim 1, wherein the lithography apparatus comprises a vacuum housing, and the at least one electronics module is in the vacuum housing.

16. The system of claim 1, wherein:
the lithography apparatus comprises a vacuum housing;
the at least one electronics module comprises first and second electronics modules;
the first electronics module is in the vacuum housing; and
the second electronics module is outside the vacuum housing.

17. The system of claim 1, wherein:
the lithography apparatus comprises a vacuum housing;
the system further comprises a driver unit and a data memory assigned to the driver unit;
the driver unit is assigned to an actuator/sensor device;
the driver unit is in the vacuum housing;
the at least one electronics module is outside the vacuum housing; and
the at least one electronics module is configured to control the driver unit and the data memory.

18. The system of claim 1, wherein:
the lithography apparatus comprises a vacuum housing;
the system further comprises a driver unit and a data memory assigned to the driver unit;
the driver unit is assigned to an actuator/sensor device;
the driver unit outside the vacuum housing;
the at least one electronics module is outside the vacuum housing; and
the at least one electronics module is configured to control the driver unit and the data memory.

19. The system of claim 1, wherein:
the lithography apparatus comprises an optical system; and
the at least one electronics module is a component of the optical system.

20. A method of operating a system comprising a lithography apparatus and at least one electronics module configured to control at least one actuator/sensor device of the lithography apparatus, the method comprising:
equipping the at least electronics module with a software component comprising a plurality of software functionalities for the lithography apparatus;
operating the software component in a default mode in which a first set of the software functionalities, which is a subset, is executed; and
operating the software component in a service mode in which a second set of the software functionalities, which is larger than the first set, is executed.
